(19) United States
(12) Patent Application Publication
(10) Pub. No.: US 2012/0194643 A1
(43) Pub. Date: Aug. 2, 2012

(54) VIDEO CODING DEVICE AND VIDEO CODING METHOD

(76) Inventor: Yuki Maruyama, Osaka (JP)

(21) Appl. No.: 13/358,578

(22) Filed: Jan. 26, 2012

(30) Foreign Application Priority Data
Jan. 31, 2011 (JP) 2011-017535
Nov. 16, 2011 (JP) 2011-251138

(51) Int. Cl. H04N 13/00

(52) U.S. Cl. 348/43; 348/E13.062

(57) ABSTRACT

A video coding device includes a three-dimensional video detection unit that determines whether an input video is a three-dimensional video or a two-dimensional video, a coding parameter setting unit that sets an upper limit value of a quantization width to be used in coding on the basis of the result of the determination by the three-dimensional video detection unit, and a coding unit that codes the input video at a quantization width not more than the upper limit value set in the coding parameter setting unit, wherein when the three-dimensional video detection unit determines that the input video is the three-dimensional video, the coding parameter setting unit sets the upper limit value of the quantization width for the three-dimensional video at a different value from the upper limit value of the quantization width for two-dimensional video.

### CROSS REFERENCE TO RELATED APPLICATIONS

The present application is based on and claims priority of Japanese Patent Application No. 2011-017535 filed on Jan. 31, 2011 and Japanese Patent Application No. 2011-251138 filed on Nov. 16, 2011. The entire disclosures of the above-identified applications, including the specification, drawings and claims are incorporated herein by reference in their entirety.

### BACKGROUND OF THE INVENTION

(1) Field of the Invention

The present invention relates to a video coding device and a video coding method that compression codes a three-dimensional video or a two-dimensional video and records the compression-coded video on a storage medium such as an optical disk, a magnetic disk, or a flash memory.

(2) Description of the Related Art

Along with development of a digital video technique, a technique for compression coding digital video data has been developed to treat an increasing amount of data. The development manifests itself in the compression coding technique making use of the characteristics of the video data and specializing in the video data.

H.264 compression coding is used as a standard for moving picture compression for the Blu-ray (Registered Trademark; hereinafter, referred to as a BD) which is one of the standards for the optical disk and AVCHD (Registered Trademark. Advanced Video Codec High Definition) which is a standard for recording a high definition video by a video camera, and the H.264 compression coding is expected to be used in wider fields.

Usually, in coding of a moving picture, the amount of information is compressed by reducing redundancy in a time direction and a space direction. In the inter picture prediction for reducing the time redundancy, the amount of a motion (hereinafter, referred to as a motion vector) is detected in block units by referring a forward or backward picture, and a prediction (hereinafter, referred to as a motion compensation) is performed considering the detected motion vector.

In the inter picture prediction, precision of the prediction is increased by the motion compensation to improve the coding efficiency. For example, in the inter picture prediction, the motion vector of an input video to be coded is detected, and a prediction difference between a prediction value obtained by shifting by the detected motion vector and the input video to be coded is coded. Thereby, the amount of information needed for coding is reduced.

Here, the picture referred to at the time of detecting the motion vector is referred to as a reference picture. Moreover, the term “picture” expresses one picture. The motion vector is detected in block units. Specifically, a block in a picture to be coded (hereinafter, referred to as a block to be coded) is fixed, and a block in a reference picture (hereinafter, referred to as a reference block) is moved within a search region.

As a result, the position of the reference block closest to the block to be coded most is found, and the motion vector is detected. The processing to search the motion vector is referred to as motion vector detection. For determination of the closeness, comparison errors in the block to be coded and the reference block are used. As the comparison error, summed absolute difference (SAD) is often used, for example.

Searching of the reference block in the whole reference picture leads to an enormous amount of operations. Accordingly, usually, the region for searching in the reference picture is limited, and the limited region is referred to as a search region.

An Intra-Picture is a picture only subjected to intra picture prediction in order to reduce spatial redundancy without undergoing the inter picture prediction. A Predictive-Picture is a picture subjected to the inter picture prediction from one reference picture. A B-Predictive Picture is a picture subjected to the inter picture prediction from two reference pictures at the maximum.

On the other hand, as a method for coding a three-dimensional video, various methods have been proposed (for example, see “A Study on Tolerance for Geometrical Distortions between L/R Images on Shooting 3D-HDTV,” (NHK), IEICE Transactions on Information and Systems Vol. J80-D-II No. 9 (1997), pp. 2522-2531). Here, a video signal including a video signal of a first view (hereinafter, referred to as a first view video) and a video signal of a second view different from the first view (hereinafter, referred to as a second view video) is referred to as a three-dimensional video.

One of the first view video and the second view video is a video for the right eye, and the other is a video for the left eye. A video signal including only the first view video signal is referred to as a two-dimensional video.

As an example of a method for coding a three-dimensional video, a method has been proposed in which the first view video is coded in the same method as in the case of the two-dimensional video, and the second view video is subjected to motion compensation using the picture of the first view video at that time as the reference picture (hereinafter, referred to as a disparity compensation method).

A merit of the method is that coding is enabled without reducing the resolutions of the first view video and the second view video compared to a side-by-side method described later. On the other hand, a demerit is that the code amount in compression is undesirably increased because the amount of pixel information is double.

As another example, a method has been proposed in which the first view video and the second view video each are ½ reduced in the horizontal direction; the reduced video signals are aligned side by side, and coded by the same method as that in the case of the two-dimensional video (hereinafter, referred to as a side-by-side method).

A merit of the method is that no additional coding device is necessary because coding is enabled by the same method as that in the case of the two-dimensional video. On the other hand, a demerit is that the realism in viewing is reduced because the resolution of the first view video and the second view video are reduced to ½ in the horizontal direction.

### SUMMARY OF THE INVENTION

It is known that cognitive contradiction is caused by viewing a three-dimensional video having a great difference in the information perceived by the eyes such as vertical deviation, deviation of inclination, and deviation of the size between the right eye video and the left eye video, causing eye fatigue or sickness (see “A Study on Tolerance for Geometrical Distortions between L/R Images on Shooting 3D-HDTV,” (NHK), IEICE Transactions on Information and Systems Vol. J80-D-II No. 9 (1997), pp. 2522-2531).

In the case where a three-dimensional video having compression distortion caused by compression coding is viewed, coding distortion such as block noise and mosquito noise appears differently in the right eye video and the left eye video. It is thought that for this reason, cognitive contradiction is caused, and it is more difficult to stereoscopically view the three-dimensional video having compression distortion than in the case of the three-dimensional video having no compression distortion.

In the BD recorder and the AVCHD video camera, a plurality of recording modes having different recording rates is often prepared, and a trade-off between the recording time and image quality is provided. In the case of recording in a recording mode at a low recording rate, however, scenes having a large quantization width are increased. For this reason, when the three-dimensional video is recorded, the image quality is more deteriorated, and eye fatigue or sickness is more often caused than in the case of recording in a recording mode at a high recording rate.

The present invention has been made in order to solve the problems above, and an object of the present invention is to provide a video coding device and video coding method in which in coding an input video as a three-dimensional video, a coded video easy to stereoscopically view can be produced.

In order to achieve the object above, a video coding device according to an embodiment of the present invention is a video coding device that codes an input video, the device comprising: a determination unit that determines whether the input video is a three-dimensional video or a two-dimensional video; a setting unit that sets an upper limit value of a quantization width to be used in coding, based on a result of the determination by the determination unit; and a coding unit that codes the input video at a quantization width not more than the set upper limit value, wherein when the determination unit determines that the input video is the three-dimensional video, the setting unit sets the upper limit value of the quantization width for the three-dimensional video at a different value from the upper limit value of the quantization width for the two-dimensional video.

Thus, the upper limit value of the quantization width to be used in coding of the two-dimensional video can be set at a different value from the upper limit value of the quantization width to be used in coding of the three-dimensional video. Thereby, the video coding device can set a coding condition according to the viewing characteristics of the two-dimensional video and the three-dimensional video, and can code the two-dimensional video and the three-dimensional video according to the respective video characteristics. Accordingly, the video coding device can produce a coded video easy to stereoscopically view in coding the input video as the three-dimensional video.

Moreover, preferably, when the determination unit determines that the input video is the three-dimensional video, the setting unit sets the upper limit value of the quantization width for the three-dimensional video at a smaller value than the upper limit value of the quantization width for the two-dimensional video.

Thus, the video coding device can reduce compression distortion of the video more in coding of the three-dimensional video than in coding of the two-dimensional video. Thereby, for example, even if a viewer does not intentionally change a coding rate when viewing the three-dimensional video, the video coding device can automatically reduce the compression distortion more than in the two-dimensional video in coding of the input video as the three-dimensional video, and produce a coded video easy to stereoscopically view.

Moreover, preferably, the setting unit sets the upper limit value of the quantization width at a different value for each picture type of the input video.

Thus, for example, in the Intra-Picture, the upper limit value of the quantization width can be set higher than that in other type pictures. Thereby, the video coding device can set the coding condition according to the video quality of the picture type, and produce a coded video easier to stereoscopically view in coding of the input video as the three-dimensional video.

Moreover, preferably, when the coding unit codes the input signal of the input video as an interlaced signal, the setting unit sets the upper limit value of the quantization width at a different value for each field of the input video.

Thus, the video coding device can set the coding condition according to the video characteristics per field, and produce a coded video easier to stereoscopically view in coding of the input video as the three-dimensional video.

Moreover, preferably, the setting unit sets an upper limit value in at least one of a quantization matrix and a quantization parameter that are information on the quantization width, thereby to set the upper limit value of the quantization width.

Thus, the video coding device can set the upper limit value of the quantization matrix or the quantization parameter to set the upper limit value of the quantization width. Thereby, the video coding device can produce a coded video easier to stereoscopically view in coding of the input video as the three-dimensional video.

The present invention can be implemented not only as such a video coding device but also as an integrated circuit including the respective processing units included in the video coding device. Moreover, the present invention can be implemented as a video coding method including the characteristic processings performed by the processing units.

Moreover, the present invention can be implemented as a program causing a computer to execute the characteristic processings included in the video coding method. Such a computer program can be distributed through a readable recording medium such as a CD-ROM and a communicating medium such as the Internet.

According to the present invention, it is determined whether the input video is a three-dimensional video or a two-dimensional video, and a method for controlling the quantization width to be used in coding is determined. For this reason, in coding the input video as the three-dimensional video, a coded video easy to stereoscopically view can be produced.

### BRIEF DESCRIPTION OF THE DRAWINGS

These and other objects, advantages and features of the invention will become apparent from the following description thereof taken in conjunction with the accompanying drawings that illustrate a specific embodiment of the present invention. In the Drawings:

FIG. 1 is a block diagram showing a configuration of a video camera according to the present embodiment;

FIG. 2 is a block diagram showing a detailed configuration of a coding unit in the video camera according to the present embodiment;

FIG. 3 is a flowchart showing an example of processing performed by the video camera according to the present embodiment; and

FIG. 4 is a flowchart showing an example of processing performed by a coding parameter setting unit and a coding unit according to a modification of the present embodiment.

### DESCRIPTION OF THE PREFERRED EMBODIMENTS

Hereinafter, embodiments of the present invention will be described with reference to the drawings. The embodiments described below show one specific preferable example of the present invention. Numeric values, components, positions of components to be disposed, forms of connection, steps, order of steps, and the like shown in the embodiments below are only an example, and the present invention will not be limited to these. The present invention is limited only by the scope of claims. Accordingly, among the components of the embodiments below, the components not described in an independent claim representing the most superordinate concept of the present invention are not always necessary to achieve the object of the present invention, but will be described as those that form more preferable embodiments.

### EMBODIMENTS

The present invention can be implemented as a video coding device included in a video capturing apparatus such as a video camera. In the present embodiment, the processing performed by a video camera including the video coding device will be described.

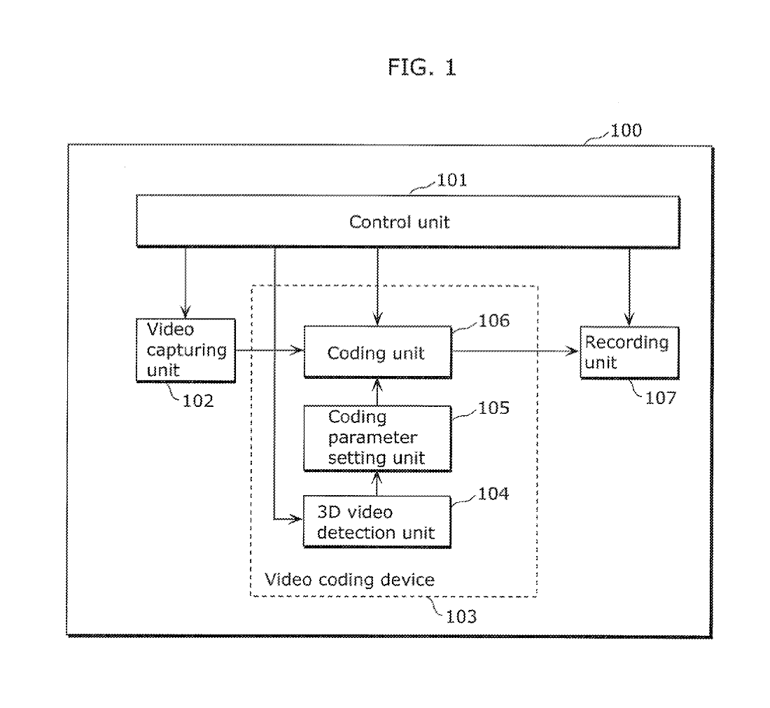

FIG. 1 is a block diagram showing a configuration of a video camera 100 according to the present embodiment. In the video camera 100 according to the present embodiment, a three-dimensional video or a two-dimensional video is input as an input video, and recorded as a stream coded by the H.264 compression method.

In the coding by the H.264 compression method, one picture is divided into one or a plurality of slices, and the slice is a processing unit. In the coding by the H.264 compression method according to the present embodiment, one picture is one slice.

In FIG. 1, the video camera 100 includes a control unit 101, a video capturing unit 102, a video coding device 103, and a recording unit 107. The video coding device 103 includes a three-dimensional video detection unit 104, a coding parameter setting unit 105, and a coding unit 106.

The control unit 101 controls the whole operation of the video camera 100. The control refers to control of the whole operation of the video camera 100, for example, whether video capturing is started or ended, whether video capturing is performed in a three-dimensional capturing mode or two-dimensional capturing mode (hereinafter, referred to as capturing mode information), control of the ISO speed, control of a zoom, and control of the recording rate. The control unit 101 outputs the information on the control above (hereinafter, referred to as control information) to the video capturing unit 102, the three-dimensional video detection unit 104, and the coding unit 106.

Based on the control information output from the control unit 101, the video capturing unit 102 forms an optical image and captures the image to obtain an input video as a digital signal. Specifically, the video capturing unit 102 produces a video for stereoscopic viewing.

The video for stereoscopic viewing includes at least a first view video produced from an optical image formed in a first view, and a second view video produced from an optical image formed in a second view. A user can view the first view video and the second view video as a stereoscopic video by viewing the first view video and the second view video by a specific displaying method.

In the present embodiment, in the case where the video capturing unit 102 captures the three-dimensional video, the video capturing unit 102 produces the first view video and the second view video, and outputs the two videos to the coding unit 106 and the three-dimensional video detection unit 104. In the case where the video capturing unit 102 captures the two-dimensional video, the video capturing unit 102 produces only the first view video, and outputs the first view video to the coding unit 106 and the three-dimensional video detection unit 104.

Based on the capturing mode information output from the control unit 101, the three-dimensional video detection unit 104 determines whether the Input video is the three-dimensional video or the two-dimensional video. Then, the three-dimensional video detection unit 104 outputs the result of determination as detection information to the coding parameter setting unit 105.

The coding parameter setting unit 105 sets the upper limit value of the quantization width to be used in coding, based on the detection information output from the three-dimensional video detection unit 104. Namely, when the three-dimensional video detection unit 104 determines that the input video is the three-dimensional video, the coding parameter setting unit 105 sets the upper limit value of the quantization width for the three-dimensional video at a different value from the upper limit value of the quantization width for the two-dimensional video.

Specifically, when based on the detection information, it is determined that the input video is the three-dimensional video, the coding parameter setting unit 105 sets a predetermined first upper limit value (hereinafter, referred to as a first upper limit value) at TH_QP. On the other hand, when based on detection information, it is determined that the input video is the two-dimensional video, the coding parameter setting unit 105 sets a predetermined second upper limit value (hereinafter, referred to as a second upper limit value) at TH_QP.

Here, the first upper limit value is set so as to be smaller than the second upper limit value. Namely, when the three-dimensional video detection unit 104 determines that the input video is the three-dimensional video, the coding parameter setting unit 105 sets the upper limit value of the quantization width for the three-dimensional video at a smaller value than the upper limit value of the quantization width for the two-dimensional video.

While the first upper limit value is a pre-set value, it may be a value that dynamically changes according to the output result from the coding unit 106. The second upper limit value is the maximum value of the quantization width that can be taken in the H.264 compression coding method, for example. The second upper limit value is not limited to the value above, and may be any value that is greater than the first upper limit value.

In the H.264 compression coding method, the quantization width is determined from a quantization matrix and a parameter Q_{P} (quantization parameter). For this reason, the coding parameter setting unit 105 may set the upper limit value in at least one of the quantization matrix and the quantization parameter Q_{P} that are the information on the quantization width, thereby to set the upper limit value of the quantization width.

Specifically, the coding parameter setting unit 105 may determine the upper limit value of the quantization width by setting both the upper limit value of the quantization matrix and that of Q_{P}. Alternatively, the coding parameter setting unit 105 may set only the upper limit value of the quantization matrix, and may set the upper limit value of the quantization width, for example, by controlling such that the coefficient of the quantization matrix is not a predetermined value or more. Alternatively, the coding parameter setting unit 105 may set only the upper limit value of the Q_{P}, and may set the upper limit value of the quantization width, for example, by controlling such that the Q_{P} is not a predetermined value or more.

The Q_{P} can be set per block to be coded. For easy control, however, the coding parameter setting unit 105 may set the upper limit value such that the Q_{P} value described in the header information inserted in slice units is not a predetermined value or more. Specifically, the coding parameter setting unit 105 sets the upper limit value such that a parameter slice_qp_delta in the slice header in the H.264 compression coding method is not a predetermined value or more.

Further, the coding parameter setting unit 105 may set the upper limit value of the quantization width at a different value for each picture type of the input video. Specifically, the coding parameter setting unit 105 may change the upper limit value for each picture type such as an Intra-Picture, a Predictive-Picture, and a B-Predictive Picture.

Alternatively, when the coding unit 106 codes an input signal of the input video as an interlaced signal, the coding parameter setting unit 105 may set the upper limit value of the quantization width at a different value for each field of the input video. Namely, when the input video includes an interlaced signal, the coding parameter setting unit 105 may change the upper limit value in the top field and in the bottom field.

Alternatively, in the case where a reference parameter for a reference quantization width is set in several seconds units or video scene units (hereinafter, referred to as a reference unit), and rate control is performed in which based on the reference parameter, the quantization width in each coding unit in the reference unit is set, the coding parameter setting unit 105 may set the upper limit value such that the reference parameter is not a predetermined value or more.

Alternatively, the coding parameter setting unit 105 may change the upper limit value of the quantization width when the first view video is coded and when the second view video is coded.

Alternatively, the coding parameter setting unit 105 may change the upper limit value according to a degree to which a generated code amount of an output stream is different from a target code amount determined from the recording rate. Specifically, the coding parameter setting unit 105 sets the upper limit value so as to be larger in the case where the generated code amount of the coded output stream is larger than the target code amount determined from the recording rate, and sets the upper limit value so as to be smaller in the case where the generated code amount of the coded output stream is smaller than the target code amount.

Alternatively, in the case where an upper limit value of the quantization width determined from a remaining volume of a DPB (decoded picture buffer) as a buffer for decoding (hereinafter, referred to as a third upper limit value) is greater than the set upper limit value of the quantization width, the coding parameter setting unit 105 may reset the upper limit value of the quantization width so as to give a priority to the third upper limit value. Namely, in this case, the coding parameter setting unit 105 resets the third upper limit value as the upper limit value of the quantization width.

Alternatively, in the case where an accumulated code amount at a recording rate at the set upper limit value of the quantization width continuously differs from an accumulated code amount at a target recording rate (target rate), the coding parameter setting unit 105 may increase the upper limit value of the quantization width so as to make the recording rate close to the target rate.

The coding unit 106 codes the input video at a quantization width not more than the upper limit value set by the coding parameter setting unit 105. Specifically, the coding unit 106 compression codes the input video output by the video capturing unit 102 by the H.264 compression method according to the recording rate output from the control unit 101 and the upper limit value of the quantization width output by the coding parameter setting unit 105.

The coding method used by the coding unit 106 will not be limited to the method above, and may be any coding method that uses the quantization width, such as the HEVC (High Efficiency Video Coding) standard of a next-generation image coding standard.

The recording unit 107 records an output stream output by the coding unit 106 in an internal memory or the like, and holds the output stream.

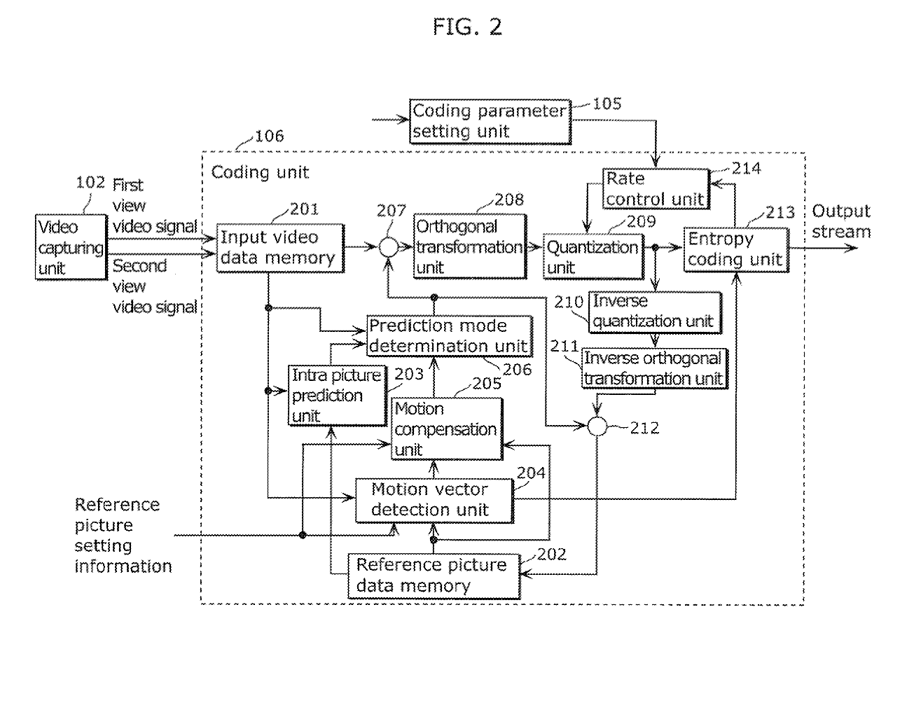

Next, using FIG. 2, a detailed configuration of the coding unit 106 will be described. FIG. 2 is a block diagram showing a detailed configuration of the coding unit 106 in the video camera 100 according to the present embodiment.

In FIG. 2, the coding unit 106 includes an input video data memory 201, a reference picture data memory 202, an intra picture prediction unit 203, a motion vector detection unit 204, a motion compensation unit 205, a prediction mode determination unit 206, a difference operation unit 207, an orthogonal transformation unit 208, a quantization unit 209, an inverse quantization unit 210, an inverse orthogonal transformation unit 211, an adder 212, an entropy coding unit 213, and a rate control unit 214.

The input video data memory 201 stores a video input from the video capturing unit 102. For example, when the first view video and the second view video are input from the video capturing unit 102, the input video data memory 201 stores two signals of the first view video signal and the second view video signal. The signal held in the input video data memory 201 is referred by the intra picture prediction unit 203, the motion vector detection unit 204, the motion compensation unit 205, the prediction mode determination unit 206, and the difference operation unit 207.

The reference picture data memory 202 stores a locally decoded picture input from the adder 212.

The intra picture prediction unit 203 performs intra picture prediction from the locally decoded picture stored in the reference picture data memory 202 using coded pixels within the same picture, to produce a prediction picture of the intra picture prediction. Then, the intra picture prediction unit 203 outputs the produced prediction picture to the prediction mode determination unit 206.

The motion vector detection unit 204 uses the locally decoded picture stored in the reference picture data memory 202 as a search target, detects an image region closest to the input video in the locally decoded picture, and determines the motion vector indicating the position of the detected image region. Then, the motion vector detection unit 204 determines the size of the block to be coded having the smallest error and the motion vector in the size, and transmits the determined information to the motion compensation unit 205 and the entropy coding unit 213.

According to the motion vector included in the information output from the motion vector detection unit 204, the motion compensation unit 205 extracts an optimal image region for the prediction picture from the locally decoded picture stored in the reference picture data memory 202. Then, the motion compensation unit 205 produces a prediction picture of the inter picture prediction, and outputs the produced prediction picture to the prediction mode determination unit 206.

The prediction mode determination unit 206 determines the prediction mode. Based on the determined result, the prediction mode determination unit 206 switches between the prediction picture produced by the intra picture prediction in the intra picture prediction unit 203 and the prediction picture produced by the inter picture prediction in the motion compensation unit 205, and outputs the prediction picture. A method for determining the prediction mode in the prediction mode determination unit 206 is as follows: the summed absolute difference between pixels in the input video and those in the prediction picture is determined in the inter picture prediction and the summed absolute difference is also determined in the intra picture prediction, and it is determined that the prediction mode with a smaller value of the determined two differences is the prediction mode, for example.

The difference operation unit 207 obtains the picture data to be coded from the input video data memory 201. Then, the difference operation unit 207 calculates a pixel difference value between the obtained input video and the prediction picture output from the prediction mode determination unit 206, and outputs the calculated pixel difference value to the orthogonal transformation unit 208.

The orthogonal transformation unit 208 converts the pixel difference value input from the difference operation unit 207 to a frequency coefficient, and outputs the converted frequency coefficient to the quantization unit 209.

Based on the quantization width input from the rate control unit 214, the quantization unit 209 quantizes the frequency coefficient input from the orthogonal transformation unit 208. Then, the quantization unit 209 outputs the quantized value, i.e., the quantization value as coded data to the entropy coding unit 213 and the inverse quantization unit 210.

The inverse quantization unit 210 inversely quantizes the quantization value input from the quantization unit 209 into a frequency coefficient, and outputs the frequency coefficient to the inverse orthogonal transformation unit 211.

The inverse orthogonal transformation unit 211 performs inverse frequency conversion on the frequency coefficient input from the inverse quantization unit 210 into a pixel difference value, and outputs the pixel difference value subjected to the inverse frequency conversion to the adder 212.

The adder 212 adds the pixel difference value input from the inverse orthogonal transformation unit 211 and the prediction picture input from the prediction mode determination unit 206 to form a locally decoded picture, and outputs the locally decoded picture to the reference picture data memory 202.

Here, the locally decoded picture stored in the reference picture data memory 202 is basically the same picture as the input video stored in the input video data memory 201, but has a distortion component such as quantization distortion because the locally decoded picture is subjected to the orthogonal transformation processing in the orthogonal transformation unit 208 and the quantization processing in the quantization unit 209 once, and then subjected to the inverse quantization processing in the inverse quantization unit 210 and the inverse orthogonal transformation processing in the inverse orthogonal transformation unit 211.

The entropy coding unit 213 performs entropy coding on the quantization value input from the quantization unit 209, the motion vector input from the motion vector detection unit 204, and the like, and outputs the coded data as an output stream.

The rate control unit 214 monitors the code amount of the output stream output by the entropy coding unit 213, and sets the quantization width such that the bit rate of the output stream is close to the recording rate output from the control unit 101.

Further, according to the upper limit value of the quantization width output by the coding parameter setting unit 105, the rate control unit 214 performs correction processing on the quantization width, and outputs the corrected quantization width to the quantization unit 209.

For example, the quantization width calculated such that the bit rate of the output stream is close to the recording rate is defined as QP, and the upper limit value of the quantization width output by the coding parameter setting unit 105 is defined as TH_QP. In this case, when QP is larger than TH_QP, the rate control unit 214 sets TH_QP or a quantization width smaller than TH_QP as a new quantization width instead of QP. Conversely, when QP is smaller than TH_QP, the rate control unit 214 sets QP as the quantization width as it is.

While the configuration has been described in which based on the output result from the entropy coding unit 213, the rate control unit 214 performs the rate control, the rate control unit 214 may perform the rate control based on the output result from the quantization unit 209.

Next, the processing performed by the thus-configured video camera 100 will be described.

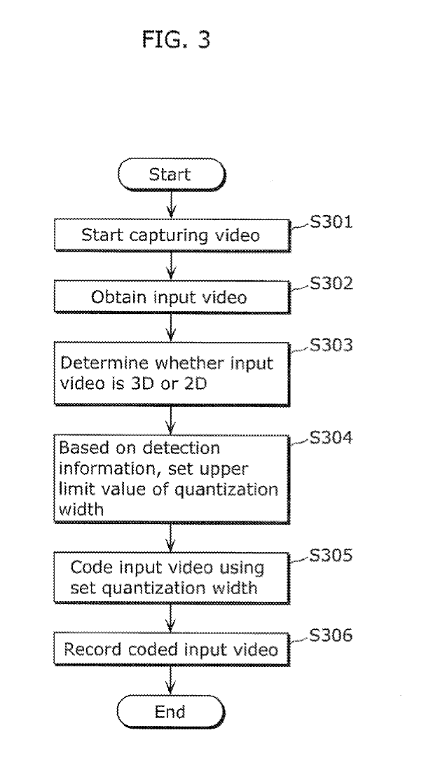

FIG. 3 is a flowchart showing an example of processing performed by the video camera 100 according to the present embodiment.

First, the control unit 101 outputs control information indicating start of video capturing to the video capturing unit 102 (S301). Examples of a specific method for controlling whether a user starts or ends video capturing include a method in which a video capturing start and end button is provided in the casing of the video camera, and the user operates the button to control the start or end of video capturing.

Next, when the video capturing unit 102 receives the control information indicating the start of video capturing from the control unit 101, the video capturing unit 102 forms an optical image and captures the image, and obtains an input video as a digital signal (S302). Then, the input video obtained as a digital signal is stored in the input video data memory 201 in the coding unit 106.

In the case of capturing the video in the three-dimensional capturing mode, the video capturing unit 102 obtains both of the first view video and the second view video as a digital signal. In the case of capturing the video in the two-dimensional capturing mode, the video capturing unit 102 obtains only the first view video as a digital signal.

In the case of capturing the video in the two-dimensional capturing mode, the input video is composed of 1920 pixels×1080 pixels, for example. In the case of capturing the video in the three-dimensional capturing mode and recording using the disparity compensation method, the first view video and the second view video each are composed of 1920 pixels×1080 pixels, for example. In the case of recording by the side-by-side method, for example, the first view video and the second view video each are reduced to ½ in the horizontal direction, the obtained picture data of 960 pixels×1080 pixels of the first view video and that of the second view video are aligned side by side to form 1920 pixels×1080 pixels, and treated as the same picture data as that of the two-dimensional video.

Next, based on the capturing mode information output from the control unit 101, the three-dimensional video detection unit 104 determines whether the input video is the three-dimensional video or the two-dimensional video (S303). Then, the three-dimensional video detection unit 104 outputs the result of the determination to the coding parameter setting unit 105 as detection information. More specifically, the three-dimensional video detection unit 104 determines that the input video is the three-dimensional video when the capturing mode is the three-dimensional capturing mode, and determines that the input video is the two-dimensional video when the capturing mode is the two-dimensional capturing mode.

Next, based on the three-dimensional video detection information output from the detection unit 104, the coding parameter setting unit 105 sets the upper limit value TH_QP of the quantization width to be used in coding (S304). Specifically, when based on the detection information, the coding parameter setting unit 105 determines that the input video is the three-dimensional video, the coding parameter setting unit 105 sets a predetermined first upper limit value as TH_QP. On the other hand, when based on the detection information, the coding parameter setting unit 105 determines that the input video is the two-dimensional video, the coding parameter setting unit 105 sets a predetermined second upper limit value in TH_QP.

Next, according to the recording rate output from the control unit 101 and the upper limit value of the quantization width TH_QP output by the coding parameter setting unit 105, the coding unit 106 codes the input video (S305). Specifically, the coding unit 106 performs a series of coding processing of motion vector detection, motion compensation, intra picture prediction, orthogonal transformation, quantization, entropy coding, rate control, and the like. In the present embodiment, the coding unit 106 codes the input video according to the H.264 coding method.

Then, the recording unit 107 records an output stream output by the coding unit 106 in an internal memory or the like, and holds the output stream (S306). The internal memory is implemented as a hard disk, a flash memory, or the like. Further, an SD card slot may be provided in the video camera 100 such that an SD card can be mounted and dismounted, and the output stream may be recorded and held on the SD card.

### Modification of Embodiment

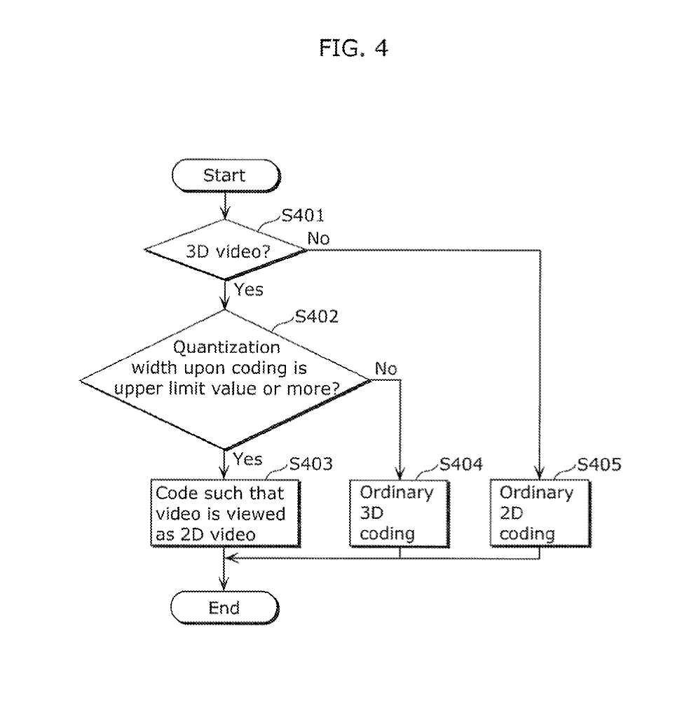

Next, using FIG. 4, other example of processing performed by the coding parameter setting unit 105 and the coding unit 106 will be described.

FIG. 4 is a flowchart showing an example of processing performed by the coding parameter setting unit 105 and the coding unit 106 according to a modification of the present embodiment.

First, based on the detection information input from the three-dimensional video detection unit 104, the coding parameter setting unit 105 determines whether the input video is the two-dimensional video or the three-dimensional video (S401). In the case where the input video is the two-dimensional video, the coding parameter setting unit 105 sets the second upper limit value, and the processing goes to S405. On the other hand, when the input video is the three-dimensional video, the coding parameter setting unit 105 sets the first upper limit value, and the processing goes to S402.

Next, when the coding parameter setting unit 105 determines that the input video is the three-dimensional video (Yes in S401), the rate control unit 214 determines whether the set quantization width is not less than the first upper limit value input from coding parameter setting unit 105 (S402). If the set quantization width is not less than the first upper limit value, the processing goes to S403. On the other hand, if the set quantization width is less than the first upper limit value, the processing goes to S404.

In the case where it is determined that the set quantization width is not less than the first upper limit value (Yes in S402), the coding unit 106 switches the operation to code the input video such that the input video is viewed as the two-dimensional video at the time of viewing (S403).

Here, examples of a method for coding an input video such that the input video is viewed as a two-dimensional video include a method for copying the coding result of the first view video in the input video to the second view video as it is, and a method using a skip macroblock in which as the coding result of the second view video, the result of coding of the first view video is referred. In short, any method may be used that can prevent stereoscopic viewing when the first view video and the second view video are viewed.

In the case where it is determined that the set quantization width is less than the first upper limit value (No in S402), based on the first upper limit value set by the coding parameter setting unit 105, the coding unit 106 codes the input video (S404). Thereby, the coding unit 106 produces the coded first view video and second view video that form the three-dimensional video.

In the case where the coding parameter setting unit 105 determines that the input video is the two-dimensional video (No in S401), based on the second upper limit value set by the coding parameter setting unit 105, the coding unit 106 codes the input video (S405). Thereby, the coding unit 106 produces the coded input video that forms the two-dimensional video.

Thus, the video camera 100 according to the present embodiment and the modification thereof determines whether the input video is the three-dimensional video or the two-dimensional video according to whether the capturing mode is the three-dimensional video capturing mode or the two-dimensional video capturing mode. Then, when the video camera 100 determines that the input video is the three-dimensional video, the quantization width calculated in the rate control unit 214 is corrected with the upper limit value of the quantization width set in the coding parameter setting unit 105, and coding is performed such that the quantization width does not exceed the set upper limit value. By thus controlling the quantization width, eye fatigue or sickness can be suppressed when the three-dimensional video having compression distortion is viewed. For this reason, the user can view the three-dimensional video comfortably.

### (Summary)

The video coding device according to the present embodiment and the modification thereof is the video coding device 103 that codes the input video, and includes the three-dimensional video detection unit 104 that determines whether the input video is the three-dimensional video or the two-dimensional video; the coding parameter setting unit 105 that sets the upper limit value of the quantization width to be used in coding, based on the result of the determination by the three-dimensional video detection unit 104; and the coding unit 106 that codes the input video at the quantization width not more than the set upper limit value, wherein when the three-dimensional video detection unit 104 determines that the input video is the three-dimensional video, the coding parameter setting unit 105 sets the upper limit value of the quantization width for the three-dimensional video at a different value from the upper limit value of the quantization width for the two-dimensional video.

Thus, the upper limit value of the quantization width to be used in coding the two-dimensional video can be set at a different value from the upper limit value of the quantization width to be used in coding the three-dimensional video. Thereby, the video coding device 103 can set the coding condition according to the viewing characteristics of the two-dimensional video and the three-dimensional video, and can code the two-dimensional video and the three-dimensional video according to the characteristics of the respective videos. Accordingly, the video coding device 103 can produce a coded video easy to stereoscopically view when the input video is coded as the three-dimensional video.

Moreover, preferably, when the three-dimensional video detection unit 104 determines that the input video is the three-dimensional video, the coding parameter setting unit 105 sets the upper limit value of the quantization width for the three-dimensional video at a smaller value than the upper limit value of the quantization width for the two-dimensional video.

Thus, the video coding device 103 can reduce compression distortion of the video more by coding the three-dimensional video than by coding the two-dimensional video. Thereby, for example, even if the viewer does not intentionally change the coding rate when viewing the three-dimensional video, the video coding device can automatically reduce the compression distortion more than in the two-dimensional video in coding of the input video as the three-dimensional video, and produce a coded video easy to stereoscopically view.

Moreover, preferably, the coding parameter setting unit 105 sets the upper limit value of the quantization width at a different value for each picture type of the input video.

Thus, for example, in the Intra-Picture, the upper limit value of the quantization width can be set higher than that in other type pictures. Thereby, the video coding device 103 can set the coding condition according to the video quality of the picture type, and produce a coded video easier to stereoscopically view in coding of the input video as the three-dimensional video.

Moreover, preferably, when the coding unit 106 codes the input signal of the input video as an interlaced signal, the coding parameter setting unit 105 sets the upper limit value of the quantization width at a different value for each field of the input video.

Thus, the video coding device 103 can set the coding condition according to the video characteristics per field, and produce a coded video easier to stereoscopically view in coding of the input video as the three-dimensional video.

Moreover, preferably, the coding parameter setting unit 105 sets the upper limit value in at least one of the quantization matrix and the quantization parameter that are the information on the quantization width, thereby to set the upper limit value of the quantization width.

Thus, the video coding device 103 can set the upper limit value of the quantization matrix or the quantization parameter to set the upper limit value of the quantization width. Thereby, the video coding device 103 can produce a coded video easier to stereoscopically view in coding of the input video as the three-dimensional video.

As above, while the present embodiment and the modification thereof have been described, the present invention will not be limited to these. Namely, the present embodiment and the modification thereof disclosed here are examples in all respects, and not to be construed as limiting the invention. It is intended that the scope of the present invention is specified by the scope of claims not by the description above, and meaning equivalent to the scope of claims and all modifications within the scope are included.

For example, while the present embodiment and the modification thereof have been described using the video camera 100, the video camera 100 may be replaced by a recorder that receives a broadcast wave.

Moreover, in the present embodiment and the modification thereof, according to the capturing mode of the video camera, the video coding device 103 determines whether the input video is the two-dimensional video or the three-dimensional video. Alternatively, based on the header information of the input video, the video coding device 103 may determine whether the input video is the two-dimensional video or the three-dimensional video. Moreover, in the case where the present invention is implemented by a recorder that receives a broadcast wave, based on the program information included in the broadcast wave as the input video, the video coding device 103 may determine whether the input video is the two-dimensional video or the three-dimensional video.

Moreover, while in the present embodiment and the modification thereof, according to the coding information on the coded stream, the video coding device 103 determines whether the input video is the three-dimensional video or the two-dimensional video, other method may be used. For example, in the case where the input video is the three-dimensional video in the side-by-side method, the video coding device 103 may perform matching processing on the picture data for the left eye and the picture data for the right eye, and according to the obtained correlation degree, the video coding device 103 may determine whether the input video is the three-dimensional video or the two-dimensional video.

Moreover, in the present embodiment and the modification thereof, the case of using H.264 as the compression coding method has been described as an example, but the method is not limited to this. For example, the present invention can be used at the time of a video compression coding method other than H.264, e.g., MPEG2.

The present invention can be implemented not only as a video coding device including the units according to the present embodiment and the modification thereof, but also a video coding method including the units including in the video coding device as processings, a video coding integrated circuit including the units included in the video coding device, and a video coding program causing a computer to execute the processings included in the video coding method.

The video coding program can be distributed through a readable recording medium such as a CD-ROM (Compact Disc-Read Only Memory) and a communication network such as the Internet.

Moreover, the video coding integrated circuit can be implemented as an LSI, which is a typical integrated circuit. In this case, the LSI may be composed of a single chip, or composed of several chips. For example, functional blocks other than a memory may be formed with a single-chip LSI. Here, the integrated circuit is the LSI, but may be referred to as an IC, a system LSI, a super LSI or ultra LSI, depending on the integration density.

Moreover, a method for forming an integrated circuit is not limited to the LSI. The integrated circuit may be implemented as a dedicated circuit or a general-purpose processor, or using an FPGA (Field Programmable Gate Array) that is programmable after production of the LSI, or a reconfigurable processor that allows a circuit cell in the LSI to be reconnected and reconfigured.

In the case where the advancement of the semiconductor technology or another derivative technology thereof introduces a new circuit integrating technique which will replace the LSI, the new technology may be employed as a matter of course to integrate the functional blocks. Examples thereof may include application of biotechnology.

Moreover, in formation of the integrated circuit, among the functional blocks, only a unit for storing data may be separately formed without being incorporated into a single chip.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The video coding device according to the present invention can code a video by the compression coding method such as H.264 such that a user can view the three-dimensional video comfortably. Accordingly, the video coding device according to the present invention can be used for recorders, video cameras, digital cameras, personal computers, mobile phones with a camera, and the like.

What is claimed is:

1. A video coding device that codes an input video, said device comprising:
a determination unit configured to determine whether the input video is a three-dimensional video or a two-dimensional video;
a setting unit configured to set an upper limit value of a quantization width to be used in coding, based on a result of the determination by said determination unit; and
a coding unit configured to code the input video at a quantization width not more than the set upper limit value,
wherein when said determination unit determines that the input video is the three-dimensional video, said setting unit is configured to set the upper limit value of the quantization width for the three-dimensional video at a different value from the upper limit value of the quantization width for the two-dimensional video.

2. The video coding device according to claim 1,
wherein when said determination unit determines that the input video is the three-dimensional video, said setting unit is configured to set the upper limit value of the quantization width for the three-dimensional video at a smaller value than the upper limit value of the quantization width for the two-dimensional video.

3. The video coding device according to claim 1,
wherein said setting unit is configured to set the upper limit value of the quantization width at a different value for each picture type of the input video.

4. The video coding device according to claim 1,
wherein when said coding unit codes the input signal of the input video as an interlaced signal, said setting unit is configured to set the upper limit value of the quantization width at a different value for each field of the input video.

5. The coding device according to claim 1,
wherein said setting unit is configured to set an upper limit value in at least one of a quantization matrix and a quantization parameter that are information on the quantization width, thereby to set the upper limit value of the quantization width.

6. A video coding method for coding an input video, comprising:
determining whether the input video is a three-dimensional video or a two-dimensional video,
setting an upper limit value of a quantization width to be used in coding, based on a result obtained in said determination, and
coding the input video at a quantization width not more than the upper limit value set in said setting,
wherein in said setting, when it is determined in said determination that the input video is the three-dimensional video, the upper limit value of the quantization width for the three-dimensional video is set at a different value from the upper limit value of the quantization width for the two-dimensional video.
